(19) United States
(12) Patent Application Publication
(10) Pub. No.: US 2026/0134053 A1
(43) Pub. Date: May 14, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Daiki KIRIBUCHI, Kawasaki Kanagawa (JP); Takufumi YOSHIDA, Funabashi Chiba (JP)

(73) Assignee: KABUSHIKI KAISHA TOSHIBA, Tokyo (JP)

(21) Appl. No.: 19/264,994

(22) Filed: Jul. 10, 2025

(30) Foreign Application Priority Data
Nov. 13, 2024 (JP) 2024-197934

(51) Int. Cl. G06F 17/11

(52) U.S. Cl. CPC G06F 17/11

(57) ABSTRACT

An information processing device according to an embodiment is a device calculating a Pareto solution of a multi-objective optimization problem that optimizes objective functions by using evaluation devices. Each objective function includes a decision variable. Each evaluation device outputs an evaluation value for evaluating an objective function value obtained by substituting setting values into the decision variables included in a corresponding objective function. The information processing device generates pieces of candidate information based on data set information including setting value sets. Each piece of candidate information includes a candidate setting value set being the same as one of the setting value sets. The information processing device selects recommendation candidate information, and generates a recommendation setting value set based on the recommendation candidate information. The information processing device supplies the recommendation setting value set to one of the evaluation devices to generate the evaluation value.

### CROSS-REFERENCE TO RELATED APPLICATIONS

This application is based upon and claims the benefit of priority from Japanese Patent Application No. 2024-197934, filed on Nov. 13, 2024; the entire contents of which are incorporated herein by reference.

### FIELD

Embodiments described herein relate generally to an information processing device, an information processing method, and a computer program product.

### BACKGROUND

In various fields, optimization processing based on simulation is utilized to improve a setting value set in a system. For example, a setting value set in a manufacturing system that manufactures a product can be calculated by the optimization processing based on simulation. In this case, an optimum setting value is calculated by optimization processing that maximizes or minimizes an objective function that evaluates the manufacturing system.

In the real world, an optimal solution is not determined by a single evaluation value, but there are many problems in which an optimal solution is determined in consideration of plural evaluation values. An optimization problem using such evaluation values is referred to as a multi-objective optimization problem. For the multi-objective optimization problem, a solution thereof is called a Pareto solution.

The evaluation values often include a trade-off relationship in which, when setting values are decided so as to improve one evaluation value, another evaluation value is deteriorated. Therefore, in the case of solving the multi-objective optimization problem, Pareto solutions having different balances of evaluation values are calculated. A user selects one Pareto solution in consideration of the trade-off relationship from among the Pareto solutions obtained by solving the multi-objective optimization problem, and decides the selected Pareto solution as the optimal solution.

In addition, the optimization processing based on simulation may be applied to the multi-objective optimization problem. As a method for solving the multi-objective optimization problem, the multi-objective Bayesian optimization method is conventionally known.

In the conventional multi-objective Bayesian optimization method, plural evaluation values are calculated simultaneously. For this reason, in the conventional multi-objective Bayesian optimization method, in a case where the contribution of the evaluation value calculated by some simulators of a plurality of simulators is small or the contribution becomes smaller, the simulator with less contribution is continuously operated. Therefore, in the conventional multi-objective Bayesian optimization method, an overall operation efficiency is deteriorated, leading to an increase in calculation cost and simulation time.

### BRIEF DESCRIPTION OF THE DRAWINGS

FIG. 1 is a configuration diagram of an information processing system according to an embodiment;

FIG. 2 is a diagram for explaining a relationship between an evaluation value and a Pareto solution;

FIG. 3 is a diagram illustrating an example of evaluation device information expressed in a graph form;

FIG. 4 is a diagram illustrating an example of evaluation device information expressed in a tabular form;

FIG. 5 is a diagram illustrating an example of data set information;

FIG. 6 is a diagram illustrating an example of candidate list information;

FIG. 7 is a diagram illustrating an example of a recommendation setting value set;

FIG. 8 is a diagram illustrating a functional configuration of a processing unit together with a storage unit;

FIG. 9 is a diagram illustrating an example of a confidence region of a Pareto front;

FIG. 10 is a flowchart illustrating a procedure of solving processing for a multi-objective optimization problem; and

FIG. 11 is a diagram illustrating a hardware configuration example of an information processing device according to the embodiment.

### DETAILED DESCRIPTION

An information processing device according to an embodiment is a device calculating a Pareto solution of a multi-objective optimization problem that optimizes objective functions by using evaluation devices corresponding to the objective functions. Each of the objective functions includes decision variables. Each of the evaluation devices outputs an evaluation value for evaluating an objective function value being obtained by substituting setting values into the decision variables included in a corresponding objective function among the objective functions. The information processing device includes a hardware processor connected to a memory. The hardware processor is configured to generates pieces of candidate information based on data set information including one or more setting value sets. Each of the pieces of candidate information including a candidate setting value set being the same as one of the one or more setting value sets. The hardware processor is configured to select recommendation candidate information from one of the pieces of candidate information. The hardware processor is configured to generate a recommendation setting value set based on the candidate setting value set included in the recommendation candidate information. The hardware processor is configured to supply the recommendation setting value set to an evaluation device out of the evaluation devices and cause the evaluation device to generate the evaluation value.

Hereinafter, embodiments of the present invention will be described in detail with reference to the accompanying drawings.

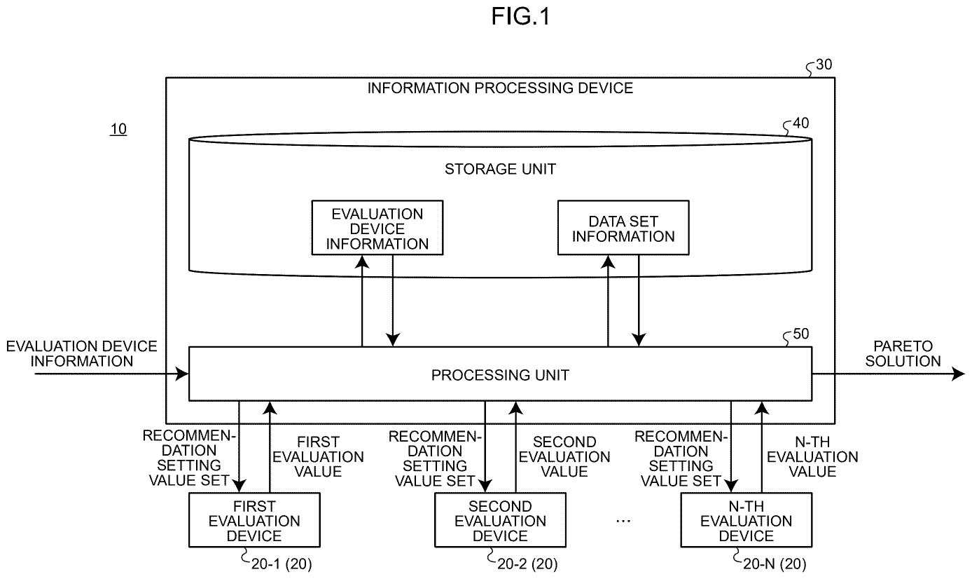

FIG. 1 is a diagram illustrating a configuration of an information processing system 10 according to an embodiment.

The information processing system 10 solves a multi-objective optimization problem. That is, the information processing system 10 outputs one or more Pareto solutions that optimize a plurality of objective functions in the multi-objective optimization problem.

Each of the objective functions is a function including a plurality of decision variables. The decision variables correspond to setting values on a one-to-one basis. Each of the decision variables is a variable representing a corresponding setting value among the setting values.

Each of the setting values is an individual value. Each of the setting values may be any of a continuous value, a discrete value, and a logical value (categorical variable). That is, the type of each of the setting values is not particularly limited.

Each of the setting values represents, for example, a value set in a setting target system. In a case where the setting target system is a production system that manufactures a product such as a semiconductor, each of the setting values is, for example, a value set in the production system such as a processing time, a dimension, a resistance, a voltage, and a charge. Each of the setting values may be a physical value set in the setting target system such as temperature and pressure, or may represent a value regarding an operating condition of the setting target system such as a processing time and a processing condition. The setting target system may be an information processing system such as a machine learning system. In this case, each of the setting values may be a hyperparameter or the like used in the machine learning system.

Each of the objective functions is, for example, a function representing an operation result, an intermediate state, a constraint, or the like in the setting target system by using a plurality of decision variables. Each of the objective functions is, for example, a function representing productivity, yield, reliability, a manufacturing time, and the like in the production system by using a plurality of decision variables. In addition, each of the objective functions may be, for example, a function representing an energy consumption amount at time, an energy constraint amount at time, the number of times of conveyance, an inspection interval, a greenhouse gas generation amount, transaction revenue, and the like in a power plant or the like by using a plurality of decision variables.

The information processing system 10 calculates and outputs one or more Pareto solutions that optimize the objective functions. Note that in the optimization processing of the multi-objective optimization problem, in a case where an objective function value of a first objective function among the objective functions is set as a best value (for example, a maximum value or a minimum value), an objective function value of a second objective function among the objective functions may not be the best value (for example, the maximum value or the minimum value). Conversely, in a case where the objective function value of the second objective function is set as the best value, the objective function value of the first objective function may not be the best value. In this regard, the user decides any one of the one or more Pareto solutions output from the information processing system 10 while considering a trade-off relationship between the evaluation values of the objective functions. Then, the user sets, in the setting target system, setting values represented by any one decided Pareto solution among the one or more Pareto solutions. As a result, the user can set setting values in the setting target system while considering tradeoffs in an operation results, an intermediate state, a constraint, or the like in the setting target system.

The information processing system 10 includes a plurality of evaluation devices 20 (20-1 to 20-N) and an information processing device 30. Note that N is an integer of 1 or more.

Each of the evaluation devices 20 corresponds to one or more objective functions among the objective functions. In addition, at least one evaluation device 20 among the evaluation devices 20 corresponds to each of the objective functions.

Each of the evaluation devices 20 outputs an evaluation value for evaluating an objective function value obtained by substituting setting values into decision variables included in the corresponding objective function among the objective functions.

A first evaluation device 20-1 of the evaluation devices 20 corresponds to the first objective function of the objective functions. The first evaluation device 20-1 outputs a first evaluation value for evaluating the objective function value of the first objective function in a case where setting values are given to the first objective function. In addition, for example, a second evaluation device 20-2 among the evaluation devices 20 corresponds to the second objective function among the objective functions. The second evaluation device 20-2 outputs a second evaluation value for evaluating the objective function value of the second objective function in a case where setting values are given to the second objective function. In addition, for example, an N-th evaluation device 20-N among the evaluation devices 20 corresponds to an N-th objective function among the objective functions. The N-th evaluation device 20-N outputs an N-th evaluation value for evaluating the objective function value of the N-th objective function in a case where setting values are given to the N-th objective function.

Each of the evaluation devices 20 is given a recommendation setting value set from the information processing device 30. The recommendation setting value set includes setting values corresponding to decision variables.

Each of the evaluation devices 20 may be given a recommendation setting value set including setting values corresponding to one or more decision variables obtained by excluding the decision variable that is not used for calculation of the corresponding objective function from the decision variables. For example, in a case where the first objective function corresponding to the first evaluation device 20-1 is represented by a function that does not include the first decision variable among the decision variables, the recommendation setting value set given to the first evaluation device 20-1 may include one or more setting values from which the setting value corresponding to the first decision variable is excluded.

In addition, the recommendation setting value set may include an evaluation value output from any of the evaluation devices 20, instead of some or all the setting values.

For example, it is assumed that the second evaluation device 20-2 outputs the second evaluation value depending on the first evaluation value output by the first evaluation device 20-1. That is, for example, it is assumed that some terms of the second objective function corresponding to the second evaluation device 20-2 are the same as those of the first objective function. In this case, the recommendation setting value set given to the second evaluation device 20-2 may include the first evaluation value output by the first evaluation device 20-1, instead of the setting value corresponding to the decision variable included only in the term of the first objective function among the decision variables. As a result, the second evaluation device 20-2 can use the first evaluation value as a result of arithmetic processing regarding the same function as the first objective function, so that the amount of calculation can be reduced.

Note that each of the evaluation devices 20 is a simulator that executes simulation by information processing based on a preset simulation model. Any one of the evaluation devices 20 may be implemented by the information processing device 30. The simulation may include an experiment. For example, at least one of the evaluation devices 20 may be an experimental device that performs a physical experiment. In the experimental device, plural recommendation setting values included in a recommendation setting value set is set via a network or is manually set by the user. The experimental device then executes an experiment and outputs an evaluation value.

The information processing device 30 includes a storage unit 40 and a processing unit 50.

The storage unit 40 can be configured by any storage medium generally used such as a flash memory, a memory card, a random access memory (RAM), a hard disk drive (HDD), and an optical disk.

The storage unit 40 stores data used for processing of the information processing device 30. The storage unit 40 stores at least the evaluation device information and data set information. The storage unit 40 may store other information. For example, the storage unit 40 may store a processing result of each component of the information processing device 30.

The processing unit 50 acquires, for example, evaluation device information input by the user at the start of the solving processing for the multi-objective optimization problem. The processing unit 50 causes the storage unit 40 to store the evaluation device information input at the start of the solving processing for the multi-objective optimization problem. In addition, the processing unit 50 may acquire the updated evaluation device information in the middle of the solving processing of the multi-objective optimization problem, and rewrite the evaluation device information stored in the storage unit 40 to the updated evaluation device information.

The processing unit 50 causes the storage unit 40 to store initial data set information at the start of the solving processing. In addition, the processing unit 50 repeatedly updates the data set information stored in the storage unit 40 during the solving processing.

During the solving processing, the processing unit 50 generates a recommendation setting value set based on the evaluation device information and the data set information, and selects the evaluation device 20 to which the recommendation setting value set is to be supplied, from among the evaluation devices 20. In a case where the recommendation setting value set is generated, the processing unit 50 gives the generated recommendation setting value set to the selected evaluation device 20. In addition, the evaluation device 20 that has received the recommendation setting value set among the evaluation devices 20 generates an evaluation value based on the received recommendation setting value set. In a case where the evaluation value is generated by any evaluation device 20 of the evaluation devices 20, the processing unit 50 acquires the generated evaluation value. In the case of acquiring the evaluation value, the processing unit 50 registers the acquired evaluation value in the data set information and updates the data set information. In a case where the data set information is updated, the processing unit 50 newly generates a recommendation setting value set based on the evaluation device information and the updated data set information. The processing unit 50 repeats generation of the recommendation setting value set, supply of the recommendation setting value set, acquisition of the evaluation value, and update of the data set information as described above during the solving processing.

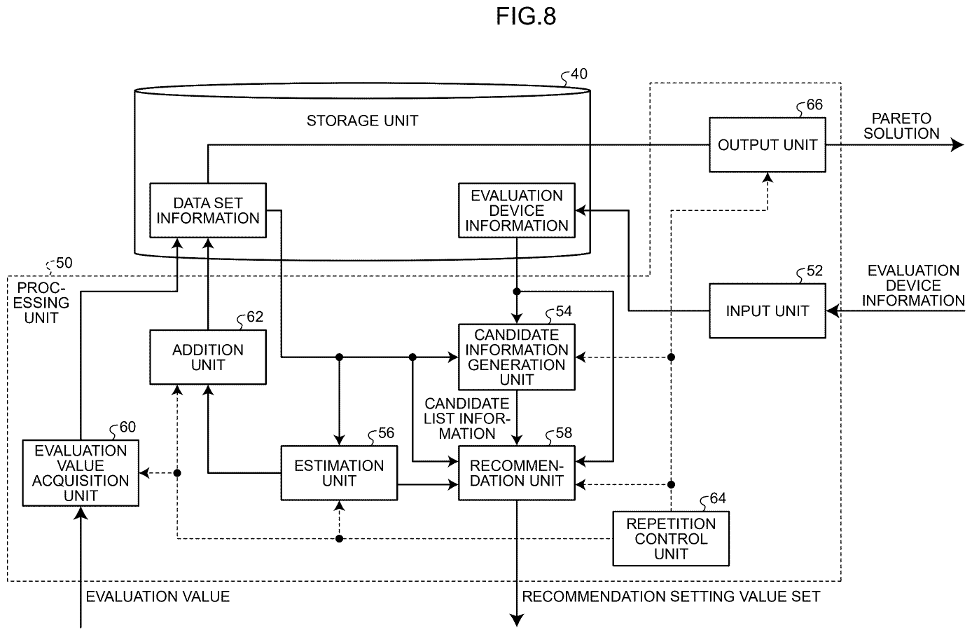

Then, in a case where a predetermined end condition is reached, the processing unit 50 stops the repetitive processing, and generates and outputs one or more Pareto solutions based on the data set information. Note that further details of the processing unit 50 will be described with reference to FIG. 8.

Note that the components illustrated in FIG. 1 are elements for performing processing of generating a recommendation setting value set and calculating and outputting one or more Pareto solutions, and other components are omitted. The components may be subdivided or grouped. For example, the storage unit 40 may be divided into two or more storage devices (for example, storage media) depending on a saved file or the like. The number of components other than the storage unit 40 may be regarded as one. The processing result of each component may be transmitted to a component to be subjected to the next processing, or may be stored in the storage unit 40. In the latter case, the component to be subjected to the next processing accesses the storage unit 40 to acquire the processing result. Alternatively, for example, the processing unit 50 may output the recommendation setting value set and information of the selected evaluation device 20 to the evaluation device 20. The evaluation device 20 may change the settings of the evaluation device 20 or the simulation model based on the information of the selected evaluation device 20, generate an evaluation value based on the recommendation setting value set, and output the evaluation value to the processing unit 50.

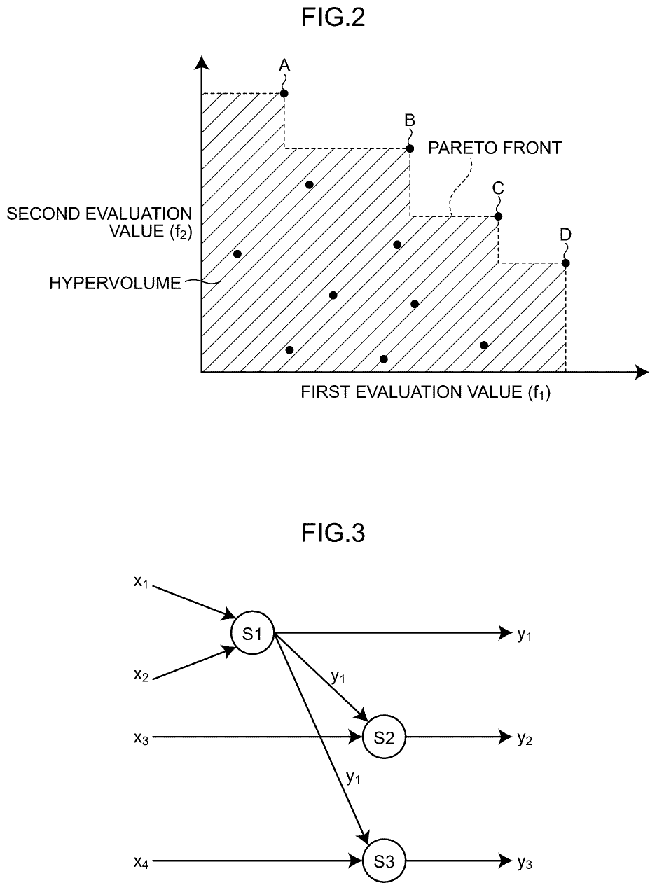

FIG. 2 is a diagram for explaining a relationship between the evaluation value and the Pareto solution.

A horizontal axis in FIG. 2 represents a first evaluation value obtained by evaluating a first objective function (f₁(x)) out of the objective functions. A vertical axis in FIG. 2 represents a second evaluation value obtained by evaluating a second objective function (f₂(x)) out of the objective functions. In the example of FIG. 2, the first evaluation value indicates a better result as the value increases, namely, as the value is closer to the right side of the graph. In the example of FIG. 2, the second evaluation value indicates a better result as the value increases, namely, as the value is closer to the upper side of the graph.

In the multi-objective optimization problem, a feasible solution is a solution that satisfies all the objective functions. In the multi-objective optimization problem, each of one or more Pareto solutions is a non-dominated solution of a solution set including plural feasible solutions. The non-dominated solution is a solution for which there is no other solution being superior in terms of the objective function value for each of the objective functions, in the solution set including the feasible solutions. Note that each of one or more ideal Pareto solutions is a non-dominated solution in a solution set including all feasible solutions. However, the information processing device 30 according to the embodiment is not limited to the ideal Pareto solution, and may output an approximate Pareto solution. That is, the information processing device 30 outputs, as the one or more Pareto solutions, one or more non-dominated solutions of the solution set including some of the feasible solutions.

In the example of FIG. 2, each of filled circles represents one of the feasible solutions. In addition, filled circles of A, B, C, and D represent Pareto solutions calculated by the information processing device 30. That is, each of the filled circles of A, B, C, and D represents a non-dominated solution in a set of feasible solutions satisfying objective functions calculated by the information processing device 30.

A hyperplane representing a boundary of feasible solutions obtained by connecting plural Pareto solutions is referred to as a Pareto front. In addition, as indicated by hatching in FIG. 2, a region including a solution set of feasible solutions having the Pareto front as a boundary is referred to as a hypervolume.

In the present embodiment, the number of the decision variables is M. M is an integer of 2 or more. In the present embodiment, the number of the objective functions is N. N is an integer of 2 or more. In such a case, a multi-objective minimization problem that is an example of the multi-objective optimization problem is expressed as Expression (1).

$$minimize \{ {f}_{1} ( {x}_{1} , {x}_{2} , {x}_{3} , ⋯ , {x}_{M} ) , {f}_{2} ( {x}_{1} , {x}_{2} , {x}_{3} , ⋯ , {x}_{M} ) , ⋯ , {f}_{N} ( {x}_{1} , {x}_{2} , {x}_{3} , ⋯ , {x}_{M} ) \} \qquad ( 1 )$$

In addition, in the present embodiment, the Pareto solutions are expressed as, for example, following Expression (2). Note that H is an integer of 2 or more.

$${X}_{1} = \{ {x}_{1} = - 1. , {x}_{2} = 1.8 , {x}_{3} = - 4.5 , ⋯ , {x}_{N} = 0.2 \} \qquad ( 2 )$$

$${X}_{2} = \{ {x}_{1} = 3. , {x}_{2} = 2.4 , {x}_{3} = 2.2 , ⋯ , {x}_{N} = 5.1 \}$$

$$⋮$$

$${X}_{H} = \{ {x}_{1} = 2.2 , {x}_{2} = - 2.7 , {x}_{3} = 0.3 , ⋯ , {x}_{N} = - 3.7 \}$$

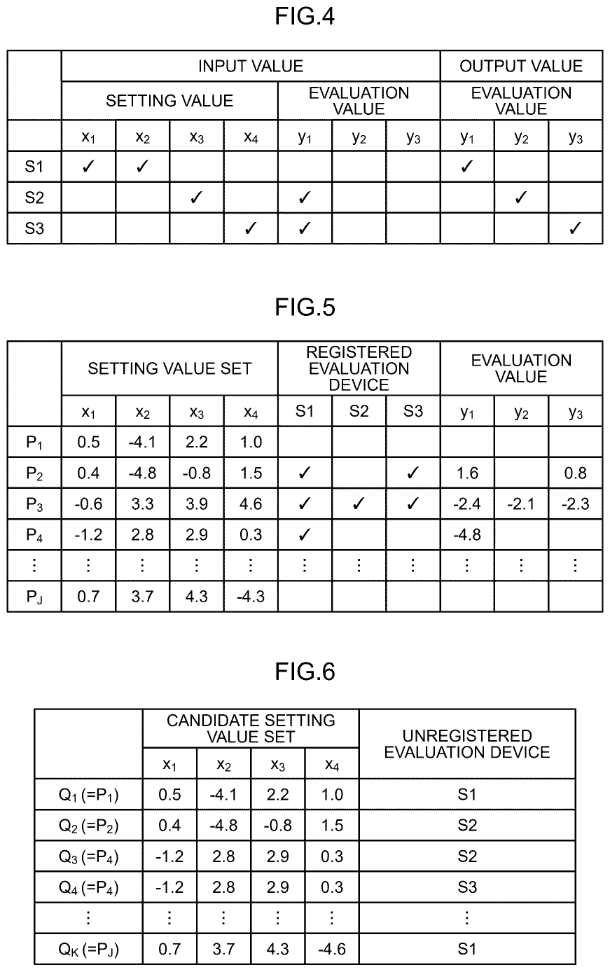

FIG. 3 is a diagram illustrating an example of evaluation device information expressed in a graph format. FIG. 4 is a diagram illustrating an example of evaluation device information expressed in a tabular form.

At least one input value is input to each of the evaluation devices 20. Each of the at least one input value is any one of setting values or any one of evaluation values. For example, each of at least one input value input to the first evaluation device 20-1 among the evaluation devices 20 is one of the setting values or an evaluation value output from any evaluation device 20 different from the first evaluation device 20-1 among the evaluation devices 20.

The evaluation device information indicates, for each of the evaluation devices 20, information for identifying at least one input value and information for identifying one of the objective functions for which an evaluation value is to be output. In one example, the evaluation device information includes, for the first evaluation device 20-1, information for identifying at least one input value input to the first evaluation device 20-1, and information for identifying one of the objective functions for which an evaluation value is to be output by the first evaluation device 20-1.

The evaluation device information illustrated in FIGS. 3 and 4 indicates information regarding each of the first evaluation device 20-1, the second evaluation device 20-2, and a third evaluation device 20-3 in the case of solving a multi-objective optimization problem including three objective functions (f₁(x), f₂ (x), f₃(x)). In addition, the evaluation device information illustrated in FIGS. 3 and 4 indicates that each of the three objective functions (f₁(x), f₂ (x), f₃(x)) is represented by four decision variables (x₁, x₂, x₃, x₄).

In FIGS. 3 and 4, the first evaluation device 20-1 is denoted by S1, the second evaluation device 20-2 is denoted by S2, and the third evaluation device 20-3 is denoted by S3. The evaluation device information illustrated in FIGS. 3 and 4 indicates that the first evaluation device 20-1 (S1) outputs the first evaluation value (y₁) obtained by evaluating the objective function value of the first objective function (f₁(x)). In addition, the evaluation device information illustrated in FIGS. 3 and 4 indicates that the second evaluation device 20-2 (S2) outputs the second evaluation value (y₂) obtained by evaluating the objective function value of the second objective function (f₂(x)). The evaluation device information illustrated in FIGS. 3 and 4 indicates that the third evaluation device 20-3 (S3) outputs the third evaluation value (y₃) obtained by evaluating the objective function value of the third objective function (f₃(x)).

The evaluation device information illustrated in FIGS. 3 and 4 indicates that a first setting value to be substituted for a first decision variable (x₁) and a second setting value to be substituted for a second decision variable (x₂) are input to the first evaluation device 20-1 (S1). The evaluation device information illustrated in FIGS. 3 and 4 indicates that a third setting value to be substituted for a third decision variable (x₃) and a first evaluation value (y₁) are input to the second evaluation device 20-2 (S2). The evaluation device information illustrated in FIGS. 3 and 4 indicates that a fourth setting value to be substituted for a fourth decision variable (x₄) and the first evaluation value (y₁) are input to the third evaluation device 20-3 (S3).

Such evaluation device information is generated in advance by the user at the start of the solving processing for the multi-objective optimization problem. Such evaluation device information may be updated during the solving processing for the multi-objective optimization problem.

The evaluation device information may be represented in a graph form as illustrated in FIG. 3. The evaluation device information may be represented in a tabular form as illustrated in FIG. 4. In addition, the evaluation device information may be represented in a format other than the graph format or the tabular form.

FIG. 5 is a diagram illustrating an example of the data set information.

The data set information includes one or more setting value sets. For example, the data set information illustrated in FIG. 5 includes J setting value sets (P₁, P₂, P₃, P₄, . . . , P_{J}). J is an optional integer of 1 or more.

Each of the one or more setting value sets represents setting values to be substituted into decision variables. Each of the one or more setting value sets illustrated in FIG. 5 represents a second setting value to be substituted for the first decision variable (x₁), a second setting value to be substituted for the second decision variable (x₂), a third setting value to be substituted for the third decision variable (x₃), and a fourth setting value to be substituted for the fourth decision variable (x₄).

A first setting value set (P₁) illustrated in FIG. 5 represents {x₁=0.5, x₂=−4.1, x₃=2.2, x₄=1.0). A second setting value set (P₂) illustrated in FIG. 5 represents {x₁=0.4, x₂=−4.8, x₃=−0.8, x₄=1.5). A third setting value set (P₃) illustrated in FIG. 5 represents {x₁=−0.6, x₂=3.3, x₃=3.9, x₄=4.6). A fourth setting value set (P₄) illustrated in FIG. 5 represents {x₁=−1.2, x₂=2.8, x₃=2.9, x₄=0.3). A J-th setting value set (P_{J}) illustrated in FIG. 5 represents {x₁=0.7, x₂=3.7, x₃=4.3, x₄=−4.3).

In the data set information, a registered evaluation device, which has acquired the evaluation value, among the evaluation devices 20 can be registered to correlate with each of the one or more setting value sets. For example, the data set information includes the first setting value set as one of the one or more setting value sets, and the first evaluation device 20-1 (S1) is not registered to correlate with the first setting value set, as the registered evaluation device. Thereafter, in a case where the processing unit 50 acquires, from the first evaluation device 20-1 (S1), the first evaluation value (y₁) obtained by giving the setting values represented by the first setting value set to the first objective function (f₁), in the data set information, the first evaluation device 20-1 (S1) is additionally registered to correlate with the first setting value set, as the registered evaluation device.

In the data set information illustrated in FIG. 5, no evaluation device 20 is registered to correlate with the first setting value set (P₁), as the registered evaluation device. In the data set information illustrated in FIG. 5, the first evaluation device 20-1 (S1) and the third evaluation device 20-3 (S3) are registered to correlate with the second setting value set (P₂), as the registered evaluation devices. In the data set information illustrated in FIG. 5, the first evaluation device 20-1 (S1), the second evaluation device 20-2 (S2), and the third evaluation device 20-3 (S3) are registered to correlate with the third setting value set (P₃), as the registered evaluation devices. In the data set information illustrated in FIG. 5, the first evaluation device 20-1 (S1) is registered to correlate with the fourth setting value set (P₄), as the registered evaluation device. In the data set information illustrated in FIG. 5, no evaluation device 20 is registered to correlate with the J-th setting value set (P_{J}), as the registered evaluation device.

In the data set information, the evaluation value acquired from each of the evaluation devices 20 can be registered to correlate with each of the one or more setting value sets. For example, the data set information includes the first setting value set as one of the one or more setting value sets, and the first evaluation value (y₁) is not registered to correlate with the first setting value set. Thereafter, in a case where the processing unit 50 acquires, from the first evaluation device 20-1 (S1), the first evaluation value (y₁) obtained by giving the setting values represented by the first setting value set to the first objective function (f₁), in the data set information, the acquired first evaluation value (y₁) is additionally registered to correlate with the first setting value set.

For example, in the data set information illustrated in FIG. 5, no evaluation value is registered to correlate with the first setting value set (P₁). In the data set information illustrated in FIG. 5, the first evaluation value (y₁=1.6) and the third evaluation value (y₃=0.8) are registered to correlate with the second setting value set (P₂). In the data set information illustrated in FIG. 5, the first evaluation value (y₁=−2.4), the second evaluation value (y₂=−2.1), and the third evaluation value (y₃=−2.3) are registered to correlate with the third setting value set (P₃). In the data set information illustrated in FIG. 5, the first evaluation value (y₁=−4.8) is registered to correlate with the fourth setting value set (P₄). In the data set information illustrated in FIG. 5, no evaluation value is registered to correlate with the J-th setting value set (P_{J}).

In addition, in the data set information, a new setting value set representing setting values is added to the one or more setting value sets at every predetermined timing during the solving processing. At the time of adding the new setting value set, in the data set information, no registered evaluation device or evaluation value is registered to correlate with the new setting value set.

In addition, the data set information is initialized at the start of the solving processing. The initial data set information includes an initial setting value set representing setting values. The initial data set information may include only an initial setting value set. In the initial data set information including only the initial setting value set, any registered evaluation devices and any evaluation values are not registered.

Note that in the example of FIG. 5, the data set information is described in a tabular form, but may be described in any format.

FIG. 6 is a diagram illustrating an example of candidate list information.

The processing unit 50 repeatedly generates the candidate list information based on the evaluation device information and the data set information during the solving processing.

The candidate list information includes pieces of candidate information. For example, the candidate list information illustrated in FIG. 6 includes K pieces of candidate information (Q₁, Q₂, Q₃, Q₄, . . . , Q_{K}). K is an optional integer of 1 or more.

Each of the pieces of candidate information includes a candidate setting value set and unregistered device information indicating an unregistered evaluation device.

The candidate setting value set is the same as a setting value set that is any one of one or more setting value sets included in the data set information.

For example, the candidate setting value set included in a first candidate information (Q₁) illustrated in FIG. 6 is the same as the first setting value set (P₁) included in the data set information illustrated in FIG. 5. For example, the candidate setting value set included in a second candidate information (Q₂) illustrated in FIG. 6 is the same as the second setting value set (P₂) included in the data set information illustrated in FIG. 5. For example, the candidate setting value set included in a third candidate information (Q₃) illustrated in FIG. 6 is the same as the fourth setting value set (P₄) included in the data set information illustrated in FIG. 5. For example, the candidate setting value set included in a fourth candidate information (Q₄) illustrated in FIG. 6 is the same as the fourth setting value set (P₄) included in the data set information illustrated in FIG. 5. For example, the candidate setting value set included in a K-th candidate information (Q_{K}) illustrated in FIG. 6 is the same as the J-th setting value set (P_{J}) included in the data set information illustrated in FIG. 5.

The unregistered evaluation device indicated by the unregistered device information is the evaluation device 20, which is not registered in the data set information as the registered evaluation device corresponding to the candidate setting value set, among the evaluation devices 20.

The first candidate information (Q₁) illustrated in FIG. 6 includes the same candidate setting value set as the first setting value set (P₁) illustrated in FIG. 5. In the first setting value set (P₁) of the data set information illustrated in FIG. 5, the first evaluation device 20-1 (S1) is not registered as the registered evaluation device. Therefore, the first candidate information (Q₁) illustrated in FIG. 6 can include the unregistered device information indicating the first evaluation device 20-1 (S1) as the unregistered evaluation device.

On the other hand, the second candidate information (Q₂) illustrated in FIG. 6 includes the same candidate setting value set as the second setting value set (P₂) illustrated in FIG. 5. In the second setting value set (P₂) of the data set information illustrated in FIG. 5, the first evaluation device 20-1 (S1) is registered as the registered evaluation device. Therefore, the second candidate information (Q₂) illustrated in FIG. 6 cannot include the unregistered device information indicating the first evaluation device 20-1 (S1) as the unregistered evaluation device.

The first candidate information (Q₁) illustrated in FIG. 6 includes the unregistered device information indicating, as the unregistered evaluation device, the first evaluation device 20-1 (S1) that is not registered to correlate with the first setting value set (P₁). The second candidate information (Q₂) illustrated in FIG. 6 includes the unregistered device information indicating, as the unregistered evaluation device, the second evaluation device 20-2 (S2) that is not registered to correlate with the second setting value set (P₂). The third candidate information (Q₃) illustrated in FIG. 6 includes the unregistered device information indicating, as the unregistered evaluation device, the second evaluation device 20-2 (S2) that is not registered to correlate with the fourth setting value set (P₄). The fourth candidate information (Q₄) illustrated in FIG. 6 includes the unregistered device information indicating, as the unregistered evaluation device, the third evaluation device 20-3 (S3) that is not registered to correlate with the fourth setting value set (P₄). The K-th candidate information (Q_{K}) illustrated in FIG. 6 includes the unregistered device information indicating, as the unregistered evaluation device, the first evaluation device 20-1 (S1) that is not registered to correlate with the J-th setting value set (P_{J}).

Note that, in the example of FIG. 6, the candidate list information is described in a tabular form, but may be described in any format. In addition, in the example of FIG. 6, in the candidate list information, one unregistered evaluation device is described in one row, but plural unregistered evaluation devices may be described in one row.

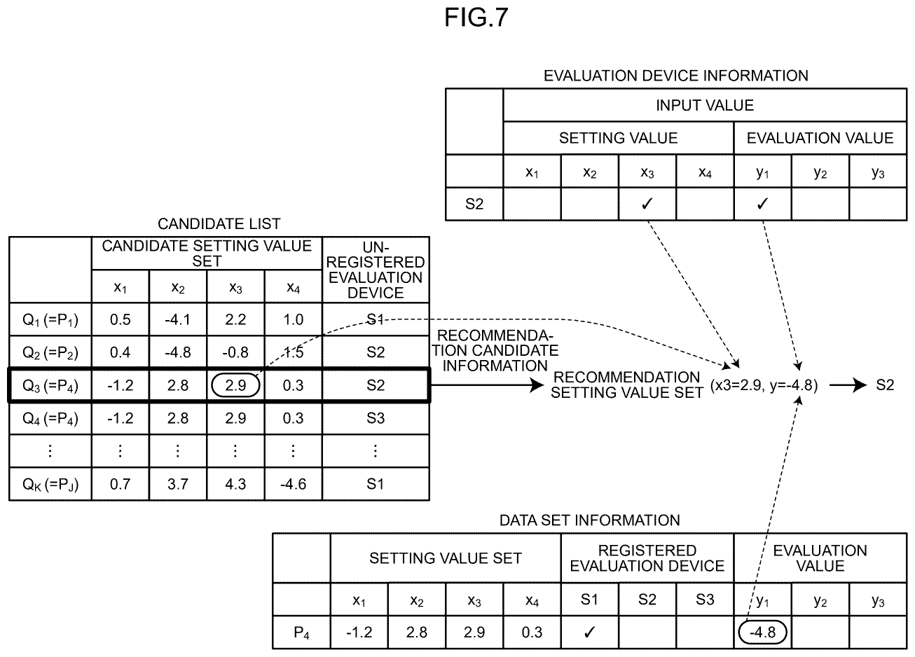

FIG. 7 is a diagram illustrating an example of the recommendation setting value set together with recommendation candidate information, evaluation device information, data set information, and candidate list information.

The processing unit 50 repeatedly generates the recommendation setting value set based on the evaluation device information, the data set information, and the candidate list information during the solving processing.

The processing unit 50 selects, as the recommendation candidate information, one of pieces of candidate information included in the candidate list information. Then, the processing unit 50 generates the recommendation setting value set based on the candidate setting value set, the evaluation device information, and the data set information included in the selected recommendation candidate information.

The recommendation setting value set includes at least one input value represented for the unregistered evaluation device in the evaluation device information, among the candidate setting value sets included in the recommendation candidate information and the evaluation values registered to correlate with the candidate setting value set in the data set information.

For example, the recommendation candidate information selected in the example of FIG. 7 is the third candidate information (Q₃) among the K pieces of candidate information (Q₁, Q₂, Q₃, Q₄, . . . , Q_{K}). The third candidate information (Q₃) includes four setting values (x₁=−1.2, x₂=2.8, x₃=2.9, x₄=0.3) and unregistered device information indicating the second evaluation device 20-2 (S2) as the unregistered evaluation device. In the example of FIG. 7, the evaluation device information indicates that the input values of the second evaluation device 20-2 (S2), which is the unregistered evaluation device, are the third setting value (x₃) and the first evaluation value (y₁). In addition, in the example of FIG. 7, the third candidate information (Q₃) is the same as the fourth setting value set (P₄) in the data set information.

Therefore, in the example of FIG. 7, the processing unit 50 generates a recommendation setting value set including the third setting value (x₃=2.9) included in the recommendation candidate information and the first evaluation value (y₁=−4.8) registered to correlate with the fourth setting value set (P₄) in the data set information. Then, the processing unit 50 supplies the generated recommendation setting value set (x₃=2.9, y₁=−4.8) to the second evaluation device 20-2 (S2) that is the unregistered evaluation device included in the recommendation candidate information. In a case where there are plural unregistered evaluation devices included in the recommendation candidate information, the processing unit 50 supplies the recommendation setting value set to each of the evaluation devices 20.

FIG. 8 is a diagram illustrating a functional configuration of the processing unit 50 together with the storage unit 40.

The processing unit 50 includes an input unit 52, a candidate information generation unit 54, an estimation unit 56, a recommendation unit 58, an evaluation value acquisition unit 60, an addition unit 62, a repetition control unit 64, and an output unit 66.

The input unit 52 acquires the evaluation device information generated by the user. The input unit 52 may acquire the evaluation device information from an external device. For example, the input unit 52 may acquire the evaluation device information in the format illustrated in FIG. 3 or FIG. 4, or may acquire the evaluation device information expressed in another format. In addition, the input unit 52 may change the format of the acquired evaluation device information.

The input unit 52 acquires the evaluation device information at the start of the solving processing of the multi-objective optimization problem, and stores the evaluation device information in the storage unit 40. In addition, the processing unit 50 may acquire the updated evaluation device information in the middle of the solving processing of the multi-objective optimization problem, and rewrite the evaluation device information stored in the storage unit 40 to the updated evaluation device information.

The input unit 52 may acquire information other than the evaluation device information. For example, the input unit 52 may acquire an end condition of the solving processing for the multi-objective optimization problem at the start of the solving processing for the multi-objective optimization problem.

The candidate information generation unit 54 generates candidate list information based on the evaluation device information and the data set information. For example, the candidate information generation unit 54 generates candidate list information including plural pieces of candidate information as illustrated in FIG. 6.

The candidate information generation unit 54 selects, as a candidate setting value set, any setting value set, which is not a setting value set in which all the evaluation devices 20 are registered as registered evaluation devices, among one or more setting value sets included in the data set information.

Further, the candidate information generation unit 54 selects an unregistered evaluation device for the selected candidate setting value set. The unregistered evaluation device is any evaluation device 20 which is not registered as a registered evaluation device for the setting value set selected as the candidate setting value set. Then, the candidate information generation unit 54 generates candidate information including the selected candidate setting value set and unregistered device information indicating the selected unregistered evaluation device.

For example, in the first setting value set (P₁) in the data set information illustrated in FIG. 5, the first evaluation device 20-1 (S1) is not registered as the registered evaluation device. Therefore, the candidate information generation unit 54 generates the first candidate information (Q₁) illustrated in FIG. 6 including the first setting value set (P₁) as the candidate setting value set and including the unregistered device information indicating the first evaluation device 20-1 (S1) as the unregistered evaluation device.

Then, the candidate information generation unit 54 generates pieces of such candidate information and incorporates the generated information into the candidate list information.

Note that the candidate information generation unit 54 does not select, as the candidate setting value set, a setting value set in which all the evaluation devices 20 are registered as registered evaluation devices, among one or more setting value sets included in the data set information.

For example, in the third setting value set (P₃) in the data set information illustrated in FIG. 5, all the first evaluation device 20-1 (S1), the second evaluation device 20-2 (S2), and the third evaluation device 20-3 (S3) are registered as registered evaluation devices. Therefore, the candidate information generation unit 54 does not generate the candidate information including, as the candidate setting value set, the third setting value set (P₃) in the data set information illustrated in FIG. 5.

In addition, the candidate information generation unit 54 generates the candidate list information so as not to generate candidate information including unregistered device information indicating, as the unregistered evaluation device, an inexecutable device among the evaluation devices 20. The inexecutable device is the evaluation device 20 which uses, as any one of at least one input value, the evaluation value output from the unregistered evaluation device.

For example, in the first setting value set (P₁) in the data set information illustrated in FIG. 5, the first evaluation device 20-1 (S1) and the second evaluation device 20-2 (S2) are not registered as the registered evaluation devices. As illustrated in FIG. 3, the second evaluation device 20-2 (S2) uses, as one input value, the first evaluation value (y₁) output from the first evaluation device 20-1 (S1). However, the first evaluation device 20-1 (S1) is an unregistered evaluation device which is not registered as the registered evaluation device for the first setting value set (P₁). That is, in a case where the first setting value set (P₁) is set as the candidate setting value set, the second evaluation device 20-2 (S2) becomes the inexecutable device. Therefore, the candidate information generation unit 54 generates the candidate list information so as not to generate the candidate information including the first setting value set (P₁) as the candidate setting value set and the unregistered device information indicating the second evaluation device 20-2 (S2) as the unregistered evaluation device.

The candidate information generation unit 54 gives, to the recommendation unit 58, the candidate list information generated in this manner.

For each of the evaluation values, the estimation unit 56 estimates a function (μⱼ⁽ⁿ⁾(x)) representing an estimated value and a function representing uncertainty of the estimated value, based on the data set information. By using this function (μⱼ⁽ⁿ⁾(x)), the estimation unit 56 can obtain an estimated value of an evaluation value obtained by supplying the candidate setting value set (x) to the unregistered evaluation device (j). In the present embodiment, the estimation unit 56 estimates, as a function representing the uncertainty of the estimated value, a function (σⱼ⁽ⁿ⁾(x)) representing an estimated standard deviation of the estimated value of the evaluation value. Note that n is an integer of 1 or more. j is an integer of 1 or more.

For example, when estimating the function (μⱼ⁽ⁿ⁾(x)) representing an estimated value for a j-th evaluation value (yⱼ) and the function (σⱼ⁽ⁿ⁾(x)) representing an estimated standard deviation, the estimation unit 56 acquires the data shown in Expression (3) from the data set information.

$${\{ {x}^{( i )} , {y}_{j}^{( i )} \}}_{i = 1}^{n} \qquad ( 3 )$$

x is a vector representing a plurality of decision variables. x⁽ⁱ⁾ represents setting values included in an i-th setting value set. yⱼ⁽ⁱ⁾ represents the j-th evaluation value registered in the i-th setting value set.

For example, in the case of estimating a function (μ₁⁽ⁿ⁾(x)) representing the estimated value of the first evaluation value (y₁) in the data set information illustrated in FIG. 5 and a function (σ₁⁽ⁿ⁾ (x)) representing the estimated standard deviation of the estimated value of the first evaluation value (y₁), the estimation unit 56 extracts each of setting value sets in which the first evaluation value (y₁) is registered and evaluation values registered to correlate with these setting value sets. More specifically, in the case of calculating the estimated value of the first evaluation value (y₁) in the data set information illustrated in FIG. 5, the estimation unit 56 extracts a set of the second setting value set (P₂) and the first evaluation value (y₁) registered to correlate with P₂, a set of the third setting value set (P₃) and the first evaluation value (y₁) registered to correlate with P₃, and a set of the fourth setting value set (P₄) and the first evaluation value (y₁) registered to correlate with P₄.

For example, for each of the evaluation values, the estimation unit 56 may estimate the function (μⱼ⁽ⁿ⁾(x)) representing the estimated value by a regression method such that a square sum of errors between the evaluation value and the estimated value is minimized. The estimation unit 56 may estimate the function (μⱼ⁽ⁿ⁾(x)) representing the estimated value, by using, as the regression method, a linear regression, a Lasso regression, an elastic net regression, a random forest regression considering monotonicity, a Gaussian process regression considering monotonicity, a neural network considering monotonicity, or the like.

In addition, for each of the evaluation values, the estimation unit 56 may estimate the function (σⱼ⁽ⁿ⁾(x)) representing the estimated standard deviation, based on a regression result. For example, the estimation unit 56 may estimate the function (σⱼ⁽ⁿ⁾(x)) representing the estimated standard deviation, based on a confidence section of the Bayesian linear regression, a variance of outputs of learned decision trees, and a variance of outputs in a case where a dropout is probabilistically performed multiple times by the neural network.

For example, in a case where the Gaussian process regression is used, the function (μⱼ⁽ⁿ⁾(x)) representing the estimated value is expressed by Expression (4).

$${μ}_{j}^{( n )} ( x ) = {μ}_{j}^{( 0 )} ( x ) + {k ( x )}^{T} {( K + {σ}_{j}^{2} I )}^{- 1} ( {y}_{j} - {m}_{j} ) \qquad ( 4 )$$

In Expression (4), an i-th decision variable is defined as x⁽ⁱ⁾, and a j-th evaluation value corresponding to the i-th decision variable (x⁽ⁱ⁾) is defined as yⱼ⁽ⁱ⁾). The i-th element of yⱼ is a vector of yⱼ⁽ⁱ⁾. μⱼ⁽⁰⁾(x) is an optional function. In Expression (4), a covariance (Kᵢₕ) of i-th setting values (x⁽ⁱ⁾) and h-th setting values (x^{(h)}) is expressed by a kernel function (k(x⁽ⁱ⁾,x^{(h)})). The kernel function is, for example, an exponential squared kernel, a magenta kernel, or a linear kernel. In addition, in Expression (4), K is a matrix in which an (i,h) element is Kᵢₕ. kᵢ(x)=k(x,x⁽ⁱ⁾), and k(x) is a vector in which the i-th element is kᵢ(x). T represents transposition. In Expression (4), σⱼ² is an optional constant, and I is an identity matrix. mⱼ represents an average value of the evaluation values.

For example, in a case where the Gaussian process regression is used, a function (σⱼ⁽ⁿ⁾(x)²) representing an estimation error that is a square of the estimated standard deviation is expressed by Expression (5).

$${{σ}_{j}^{( n )} ( x )}^{2} = k ( x , x ) - {k ( x )}^{T} {( K + {σ}_{j}^{2} I )}^{- 1} k ( x ) \qquad ( 5 )$$

In addition, for each of the evaluation values, the estimation unit 56 may estimate a function representing the estimated value and a function representing the estimated standard deviation by using the evaluation device information. Each of the evaluation devices 20 may input some of setting values as input values, instead of inputting all the setting values as input values. In such a case, for each of the evaluation values, the estimation unit 56 may estimate the function representing the estimated value and the function representing the estimated standard deviation by using the decision variables corresponding to one or more input values input to the corresponding evaluation device 20. For example, the evaluation device information indicates that the first evaluation device 20-1 which outputs the first evaluation value (y₁) in the data set information illustrated in FIG. 5 inputs the first setting value (x₁) and a second setting value (x₂). In this case, the estimation unit 56 estimates the function (μ₁⁽ⁿ⁾(x)) representing the estimated value of the first evaluation value (y₁) and the function (σ₁⁽ⁿ⁾ (x)) representing the estimated standard deviation by using the first setting value (x₁) and the second setting value (x₂) in the setting value set. As a result, the estimation unit 56 can accurately estimate the function representing the estimated value and the function representing the estimated standard deviation in a short time.

In addition, each of the evaluation devices 20 may input, as the input value, an evaluation value output from another evaluation device 20. In such a case, for each of the evaluation values, the estimation unit 56 may estimate the function representing the estimated value and the function representing the estimated standard deviation by using a function representing an estimated value of another evaluation value and a function representing an estimated standard deviation. For example, the evaluation device information indicates that the second evaluation device 20-2 which outputs the second evaluation value (y₂) in the data set information illustrated in FIG. 5 inputs the first evaluation value (y₁). In this case, the estimation unit 56 estimates a function ((μ₂⁽ⁿ⁾(x)) representing the estimated value of the second evaluation value (y₂) and a function (σ₂⁽ⁿ⁾(x)) representing the estimated standard deviation by using the function (μ₁⁽ⁿ⁾(x)) representing the estimated value of the first evaluation value (y₁) and the function (σ₁⁽ⁿ⁾(x)) representing the estimated standard deviation. As a result, the estimation unit 56 can accurately estimate the function representing the estimated value and the function representing the estimated standard deviation in a short time.

In this case, even in a case where, in any setting value set in the data set information, only the first evaluation value (y₁) is registered and the second evaluation value (y₂) is not registered, the function (μ₁⁽ⁿ⁾(x)) representing the estimated value of the first evaluation value (y₁) and the function (σ₁⁽ⁿ⁾ (x)) representing the estimated standard deviation are updated. Therefore, even when the second evaluation value (y₂) is not registered, the estimation unit 56 can update the function (μ₂⁽ⁿ⁾(x)) representing the estimated value of the second evaluation value (y₂) and the function (σ₂⁽ⁿ⁾(x)) representing the estimated standard deviation. Therefore, by performing such processing, the estimation unit 56 can estimate the function representing the estimated value and the function representing the estimated standard deviation.

In addition, the estimation unit 56 may repeat the processing by the number of the evaluation values to estimate, for each of the evaluation values, the function representing the estimated value and the function representing the estimated standard deviation. That is, for f(x)={f₁(x), f₂ (x), . . . , fₘ(x)}, the estimation unit 56 may execute processing m times such as calculating μ₁⁽ⁿ⁾(x) and σ₁⁽ⁿ⁾(x) for f₁(x), calculating μ₂⁽ⁿ⁾(x) and σ₂⁽ⁿ⁾(x) for f₂ (x), . . . , calculating μₘ⁽ⁿ⁾(x) and σₘ⁽ⁿ⁾(x) for fₘ(x). In addition, the estimation unit 56 may simultaneously calculate the function representing the estimated value of each of the evaluation values and the function representing the estimated standard deviation by using a multi-output regression method.

The estimation unit 56 gives, to the recommendation unit 58, the function representing the estimated value for each of the evaluation values as described above and the function representing the uncertainty of the estimated value.

The recommendation unit 58 acquires the data set information, the evaluation device information, and the candidate list information. In addition, the recommendation unit 58 acquires the function representing the estimated value for each of the evaluation values and the function representing the uncertainty of the estimated value.

The recommendation unit 58 selects, as the recommendation candidate information, one of pieces of information included in the candidate list information. Subsequently, the recommendation unit 58 generates a recommendation setting value set based on the candidate setting value set included in the recommendation candidate information. Then, the recommendation unit 58 supplies the recommendation setting value set to the unregistered evaluation device indicated by the unregistered device information included in the recommendation candidate information, and causes the unregistered evaluation device to generate an evaluation value.

The recommendation unit 58 selects, as the recommendation candidate information, one of pieces of candidate information included in the candidate list information, based on the function representing the estimated value for each of the evaluation values and the function representing the uncertainty of the estimated value. For example, the recommendation unit 58 may select the recommendation candidate information by using a black box optimization method. In addition, for example, the recommendation unit 58 may select the recommendation candidate information by using a genetic algorithm. In addition, for example, the recommendation unit 58 may select the recommendation candidate information by using an evolution strategy, CMA-ES, or Bayesian optimization.

For example, for each of the pieces of candidate information included in the candidate list information, the recommendation unit 58 generates an acquisition function representing a quality of the evaluation value obtained by supplying the candidate setting value set to the unregistered evaluation device. That is, for each of the pieces of candidate information included in the candidate list information, the recommendation unit 58 generates the acquisition function (αⱼ⁽ⁿ⁾(x)) representing the quality of the evaluation value obtained by supplying the candidate setting value set (x) to the unregistered evaluation device (j). For each of the pieces of candidate information, the recommendation unit 58 calculates the function representing the estimated value and the function representing the uncertainty of the estimated value with respect to the evaluation value obtained by supplying the candidate setting value set to the unregistered evaluation device, based on the function representing the estimated value for each of the evaluation values and the function representing the uncertainty of the estimated value. Subsequently, for each of the pieces of candidate information, the recommendation unit 58 calculates the acquisition function based on the function representing the estimated value and the function representing the uncertainty of the estimated value.

In one example, the recommendation unit 58 may calculate the acquisition function by using expected hypervolume improvement (EHVI).

Subsequently, for each of the pieces of candidate information included in the candidate list information, the recommendation unit 58 calculates the acquisition function value (αⱼ⁽ⁿ⁾(x)) by giving the unregistered evaluation device (j) and the candidate setting value set (x) to the acquisition function representing the quality of the evaluation value obtained by supplying the candidate setting value set to the unregistered evaluation device. Then, the recommendation unit 58 selects the recommendation candidate information (a combination of the unregistered evaluation device (j) and the candidate setting value set (x)) from the pieces of candidate information based on the acquisition function value of each of the pieces of candidate information. For example, the recommendation unit 58 selects, as the recommendation candidate information, candidate information having a maximum acquisition function value among the pieces of candidate information. Alternatively, for example, the recommendation unit 58 may maximize the acquisition function by using an optional optimization method. For example, the recommendation unit 58 may maximize the acquisition function by using a full search, a random search, a grid search, a gradient method, L-BFGS, DIRECT, CMA-ES, or a multi-start local method.

Note that since the number of setting value sets included in the data set information is small, the candidate list information may not include the candidate information. For example, immediately after the optimization processing is started, the candidate list information may not include the candidate information. In such a case, the recommendation unit 58 may generate a preset recommendation setting value set. In addition, for example, the recommendation unit 58 may set the setting values and the unregistered evaluation device by using a random number, a Latin square, a Sobol sequence, a grid point, and the like.

Every time the recommendation unit 58 supplies the recommendation setting value set to the unregistered evaluation device, the evaluation value acquisition unit 60 acquires, from the unregistered evaluation device, the evaluation value calculated according to the recommendation setting value set. In response to the acquisition of the evaluation value, in the data set information, the evaluation value acquisition unit 60 registers, as the registered evaluation device, the unregistered evaluation device, corresponding to the recommendation setting value set, which is supplied to the unregistered evaluation device, among one or more setting value sets. Along with this, in response to the acquisition of the evaluation value, in the data set information, the evaluation value acquisition unit 60 registers the acquired evaluation value, corresponding to the recommendation setting value set, which is supplied to the unregistered evaluation device, among one or more setting value sets.

The addition unit 62 stores, in the storage unit 40, the data set information including one or more initial setting value sets at the start of the solving processing. For example, at the start of the solving processing, the addition unit 62 acquires, from an external device, an initial setting value set representing plural values to be substituted for decision variables or acquires an initial candidate value set from the user, and stores, in a storage unit 42, the data set information including the acquired initial candidate value set.

For example, at the start of the solving processing, the addition unit 62 may generate an initial setting value set by using a random number, a Latin square, a Sobol column, a grid point, and the like, and store, in the storage unit 42, data set information including the generated initial candidate value set. In addition, the addition unit 62 may acquire a variable range for each of the decision variables, and generate an initial setting value set within the acquired variable range by using a random number, a Latin square, a Sobol column, a grid point, and the like.

In addition, the addition unit 62 updates the data set information stored in the storage unit 42. For example, during the solving processing, the addition unit 62 generates a new setting value set representing plural values to be substituted into the decision variables at every predetermined timing, and adds the generated new setting value set to one or more setting value sets included in the data set information.

For example, every time the recommendation setting value set is supplied to any one of the evaluation devices 20, the addition unit 62 adds the new setting value set to one or more setting value sets included in the data set information. In addition, every time the recommendation setting value set is supplied to any one of the evaluation devices 20 a predetermined number of times, every predetermined time, or every time a predetermined condition is satisfied, the addition unit 62 may add the new setting value set to one or more setting value sets included in the data set information.

The addition unit 62 may generate the new setting value set by using, for example, a random number, a Latin square, a Sobol column, and a grid point. In addition, the addition unit 62 may generate the new setting value set within the variable range for each of the decision variables.

In addition, the addition unit 62 may generate estimation functions obtained by estimating objective functions, based on the data set information, and generate a new setting value set based on the generated estimation functions. For example, the addition unit 62 may acquire, as the estimation functions, plural functions (μ₁⁽ⁿ⁾(x), μ₂⁽ⁿ⁾(x), . . . ) each estimated by the estimation unit 56 and representing the evaluation value and generate the new setting value set.

For example, the addition unit 62 calculates a non-dominated solution of a multi-objective optimization problem that optimizes the estimation functions, by a genetic algorithm such as NSGA-II. Then, the addition unit 62 generates the new setting value set based on the calculated non-dominated solution. In addition, the addition unit 62 may generate the new setting value set by replacing part of any setting value set of one or more setting value sets included in the data set information with part of the calculated non-dominated solution.

The repetition control unit 64 controls the repetitive processing in the processing unit 50 in the solving processing. That is, the repetition control unit 64 controls the repetition of the generation of the candidate list information by the candidate information generation unit 54, the generation of the function representing the estimated value and the function representing the uncertainty of the estimated value by the estimation unit 56, the generation of the acquisition function by the recommendation unit 58, the selection of the recommendation candidate information by the recommendation unit 58, the supply of the recommendation setting value set by the recommendation unit 58, the acquisition of the evaluation value by the evaluation value acquisition unit 60, and the registration of the registered evaluation device and the evaluation value to the data set information by the evaluation value acquisition unit 60.

In a case where a predetermined end condition is reached, the repetition control unit 64 ends the repetitive processing. For example, in a case where the processing is repeated a predetermined number of times or in a case where a predetermined time has elapsed, the repetition control unit 64 determines that the end condition is reached.

In a case where the predetermined end condition is reached, the output unit 66 selects one or more setting value sets that are non-dominated solutions with respect to objective functions, from the data set information of the state after the end condition is reached. Then, the output unit 66 outputs the selected one or more setting value sets as one or more Pareto solutions.

The output unit 66 may output the one or more Pareto solutions in any data format. For example, the output unit 66 may convert plural Pareto solutions into image data and output the image data, may display the Pareto solutions in a graph format, or may output the Pareto solutions in a tabular form. In addition, the output unit 66 may output data included in the data set information of the state after the end condition is reached, together with the one or more Pareto solutions.

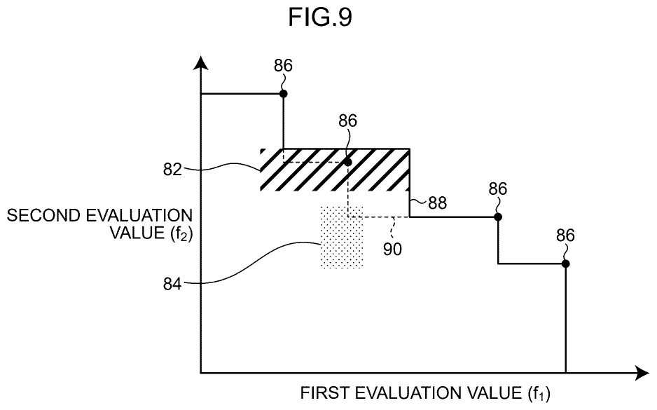

FIG. 9 is a diagram illustrating an example of a confidence region of the Pareto front.

The recommendation unit 58 may calculate the acquisition function as follows, for example, based on the confidence region of the Pareto front.

First, for each of the pieces of candidate information, the recommendation unit 58 calculates a confidence region of a target objective function among the objective functions, based on the function representing the estimated value and the function representing the uncertainty of the estimated value with respect to the evaluation value obtained by supplying the candidate setting value set to the unregistered evaluation device.

The confidence region is a direct product of a section that satisfies Expression (6) for each of evaluation values (yᵢ). Note that βⱼ⁽ⁿ⁾ is an optional constant.

$${μ}_{j}^{( n )} ( x ) - \sqrt{{β}_{j}^{( n )}} {σ}_{j}^{( n )} ( x ) \leq {y}_{j} \leq {μ}_{j}^{( n )} ( x ) + \sqrt{{β}_{j}^{( n )}} {σ}_{j}^{( n )} ( x ) \qquad ( 6 )$$

In addition, the confidence region may be a direct product of a section that satisfies Expression (7) for each of the evaluation values (yᵢ).

$${μ}_{j}^{( n )} ( x ) - \sqrt{{β}_{j}^{( n )}} {σ}_{j}^{( n )} ( x ) \leq {y}_{j} \leq {μ}_{j}^{( n )} ( x ) \qquad ( 7 )$$

Subsequently, with respect to the evaluation value for each of the pieces of candidate information, the recommendation unit 58 calculates the confidence region of the Pareto front of the target objective function based on the confidence region of the target objective function.

The Pareto Front is a hyperplane created by an objective function of a decision variable that is not dominated by an objective function of any other decision variable. The recommendation unit 58 calculates, as a maximum value, a point having the largest value in the confidence region of the target objective function for each decision variable, and calculates a Pareto Front at which all the decision variables have the maximum value. Similarly, the recommendation unit 58 calculates, as a minimum value, a point having the smallest value in the confidence region of the target objective function for each decision variable, and calculates a Pareto Front at which all the decision variables have the minimum value. Then, the recommendation unit 58 calculates a region between the two Pareto fronts as the confidence region of the Pareto front of the target objective function.

A horizontal axis in FIG. 9 represents the first evaluation value obtained by evaluating the first objective function (f₁(x)) among the objective functions. A vertical axis in FIG. 9 represents the second evaluation value obtained by evaluating the second objective function (f₂(x)) among the objective functions.

In the example of FIG. 9, the confidence region of the Pareto front of the objective function is a first region 82 hatched with oblique lines in FIG. 9, a second region 84 hatched with dots in FIG. 9, and point regions 86 indicated by filled circles in FIG. 9. Note that in a case where the estimated standard deviation is 0, the confidence region is represented by a point.

In the first region 82, a point having the largest value in each dimension is a point at the upper right corner, and a point having the smallest value in each dimension is a point at the lower left corner. The Pareto front in which all the decision variables have the maximum value is a first line 88 represented by a solid line in the upper right of the first region 82. The Pareto Front at which all the decision variables have the minimum value is a second line 90 represented by a dotted line partly passing below the left side of the first line 88. Note that the first line 88 and the second line 90 partly overlap with each other. In the example of FIG. 9, the confidence region of the Pareto front of the target objective function is a region between the first line 88 and the second line 90.

Then, the recommendation unit 58 may calculate, as the acquisition function, a function representing the amount of decrease in the confidence region of the Pareto front in a case where the function representing the uncertainty of the estimated value with respect to the evaluation value is 0.

For example, in a case where the setting value included in the candidate setting value set is x⁽¹⁰⁾ and the unregistered evaluation device is the first evaluation device 20-1, the recommendation unit 58 sets σ₁⁽ⁿ⁾(x⁽¹⁰⁾) as 0. The recommendation unit 58 calculates the confidence region of the Pareto front of the objective function without changing anything other than σ₁⁽ⁿ⁾(x⁽¹⁰⁾). The recommendation unit 58 calculates a difference between the confidence regions of the Pareto front of the two objective functions, and sets the calculated difference as the acquisition function. In addition, the recommendation unit 58 may calculate, as a new acquisition function, an acquisition function per unit cost obtained by dividing the calculated difference by a calculation cost of each of the evaluation devices 20 or a logarithm of the calculation cost. In addition, in a case where there are plural unregistered evaluation devices, the recommendation unit 58 may set, to 0, the function representing the uncertainty of the estimated value with respect to the evaluation value of each of the unregistered evaluation devices.

In addition, the recommendation unit 58 may calculate the acquisition function based on a hypervolume improvement amount as follows. The hypervolume is a hypervolume of a region between the Pareto front and a reference point.

First, the recommendation unit 58 calculates a first hypervolume based on a setting value set, in which evaluation values for all the evaluation devices 20 are registered, among one or more setting value sets included in the data set information.

Subsequently, for each of the pieces of candidate information, the recommendation unit 58 calculates a second hypervolume obtained by supplying the candidate setting value set to the unregistered evaluation device based on the function representing the estimated value for each of the evaluation values obtained by supplying the candidate setting value set to the unregistered evaluation device and the function representing the uncertainty of the estimated value.

In this case, the recommendation unit 58 may assume the estimated value for each of the evaluation values obtained by supplying the candidate setting value set (x) to the unregistered evaluation device (j) as Expression (8) or Expression (9).

$${μ}_{j}^{( n )} ( x ) \qquad ( 8 )$$

$${μ}_{j}^{( n )} ( x ) - \sqrt{{β}_{j}^{( n )}} {σ}_{j}^{( n )} ( x ) \qquad ( 9 )$$

In addition, for each of the pieces of candidate information, the recommendation unit 58 may calculate the second hypervolume based on the estimated value of the evaluation value obtained by supplying the candidate setting value set to the unregistered evaluation device and the evaluation values output from all the other evaluation devices 20.

Then, for each of the pieces of candidate information, the recommendation unit 58 calculates, as the acquisition function, a function representing a difference between the first hypervolume and the second hypervolume.

The difference between the first hypervolume and the second hypervolume represents the hypervolume improvement amount in a case where evaluation is performed with certain candidate information. The recommendation unit 58 can efficiently improve the hypervolume as the hypervolume improvement amount increases. Note that the recommendation unit 58 may calculate, as a new acquisition function, an acquisition function per unit cost obtained by dividing the difference between the first hypervolume and the second hypervolume by the calculation cost of each of the evaluation devices 20 or the logarithm of the calculation cost. Alternatively, the recommendation unit 58 may calculate, as the acquisition function, an expected hypervolume improvement amount after repeating g times of evaluation, and select recommendation candidate information having the maximum acquisition function. For example, the recommendation unit 58 evaluates the candidate setting value set (x) by the unregistered evaluation device (j) at the first time. A strategy is considered, which performs evaluation with another unregistered evaluation device (k (+j)) on the same candidate setting value set (x) for second and subsequent times in a case where a first evaluation value is equal to or larger than a threshold, and performs evaluation with an optional unregistered evaluation device on another candidate setting value set (x′ (x)) for the second and subsequent times in a case where the first evaluation value is smaller than the threshold. The recommendation unit 58 calculates, as the acquisition function, an expected hypervolume improvement amount in the evaluation values obtained up to the g-th evaluation of this strategy. The recommendation unit 58 obtains a first unregistered evaluation device (j) having the largest acquisition function and a candidate setting value set (x) among the candidate information, and uses the obtained unregistered evaluation device (j) and candidate setting value set (x) as the recommendation candidate information.

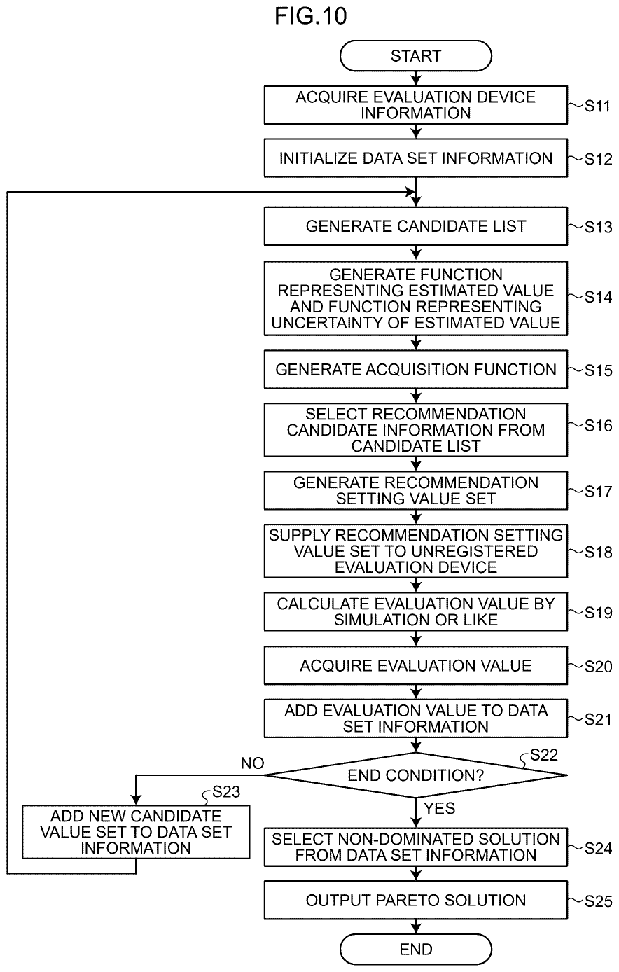

FIG. 10 is a flowchart illustrating a procedure of the solving processing for the multi-objective optimization problem performed by the information processing system 10 according to the embodiment. The information processing system 10 according to the embodiment executes the solving processing for the multi-objective optimization problem according to the flow illustrated in FIG. 10.

First, in S11, the processing unit 50 acquires evaluation device information and stores the evaluation device information in the storage unit 40.

Subsequently, in S12, the processing unit 50 initializes data set information. For example, the processing unit 50 causes the storage unit 40 to store initial data set information including one or more initial setting value sets.

Subsequently, in S13, the processing unit 50 generates a candidate list including pieces of candidate information based on the data set information and the evaluation device information.

Subsequently, in S14, for each of evaluation values, the processing unit 50 estimates a function representing an estimated value and a function representing uncertainty of the estimated value based on the data set information. For example, for each of the evaluation values, the processing unit 50 estimates the function representing the estimated value by a regression method such that a square sum of errors between the evaluation value and the estimated value is minimized. In addition, the processing unit 50 estimates a function representing an estimated standard deviation based on the regression result for each of the evaluation values.

Subsequently, in S15, for each of pieces of candidate information included in candidate list information, the processing unit 50 generates an acquisition function representing a quality of an evaluation value obtained from an unregistered evaluation device.

Subsequently, in S16, for each of the pieces of candidate information included in the candidate list information, the processing unit 50 calculates an acquisition function value by giving the unregistered evaluation device and a candidate setting value set to the generated acquisition function. Then, the processing unit 50 selects one piece of recommendation candidate information among the pieces of candidate information, based on the acquisition function value of each of the pieces of candidate information included in the candidate list information.

Subsequently, in S17, the processing unit 50 generates a recommendation setting value set based on the selected recommendation candidate information, evaluation device information, and the data set information. For example, the processing unit 50 determines a type of an input value to be input to the unregistered evaluation device indicated by the recommendation candidate information, based on the evaluation device information. Then, the processing unit 50 acquires an input value having the determined type from the candidate setting value set included in the recommendation candidate information and one or more evaluation values registered to correlate with the candidate setting set included in the data set information, and generates a recommendation setting value set.

Subsequently, in S18, the processing unit 50 supplies the generated recommendation setting value set to the unregistered evaluation device indicated by selection candidate information.

Subsequently, in S19, the evaluation device 20, which is the unregistered evaluation device having acquired the recommendation setting value set, calculates an evaluation value by simulation or the like based on the recommendation setting value set.

Subsequently, in S20, the processing unit 50 acquires the evaluation value calculated by simulation or the like from the evaluation device 20 that is the unregistered evaluation device.

Subsequently, in S21, the processing unit 50 registers the acquired evaluation value in the data set information. In this case, the processing unit 50 registers the acquired evaluation value, corresponding to the setting value set that is included in the data set information and is the same as the recommendation setting value set included in the selection candidate information selected in S16.

Subsequently, in S22, the processing unit 50 determines whether or not a predetermined end condition has been reached. For example, in a case where the processing from S13 to S21 is repeated a predetermined number of times or in a case where a predetermined time has elapsed, the processing unit 50 determines that the end condition is reached. If the end condition is not reached (No in S22), the processing unit 50 advances the processing to S23. If the end condition is reached (Yes in S22), the processing unit 50 advances the processing to S24.

In S23, the processing unit 50 generates a new setting value set, and adds the generated new setting value set to one or more setting value sets included in the data set information stored in the storage unit 40. The processing unit 50 may execute the processing of S23 every time, or may execute the processing of S13 every time the processing from S23 to S21 is executed a predetermined number of times.

When S23 is completed, the processing unit 50 returns the processing to S13. Then, the processing unit 50 repeats the processing from S13 to S23 until the end condition is reached.

In S24, the processing unit 50 selects, from the data set information, one or more setting value sets that are non-dominated solutions with respect to plural objective functions.

Subsequently, in S25, the processing unit 50 outputs the selected one or more setting value sets as one or more Pareto solutions.

When the processing of S25 is completed, the processing unit 50 ends this flow.

The information processing system 10 as described above repeats the processing of calculating the evaluation value, by using the evaluation device 20, which calculates the evaluation value having a large contribution to the calculated Pareto solution, among the evaluation devices 20. As a result, according to the information processing system 10, it is possible to efficiently calculate one or more Pareto solutions that optimize objective functions in the multi-objective optimization problem, by using the evaluation devices 20.

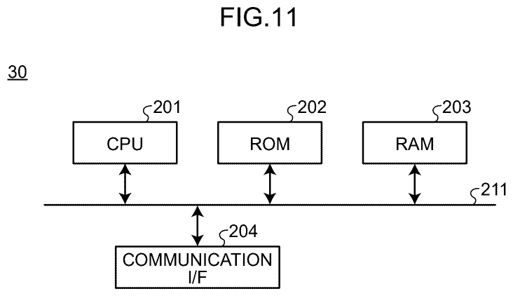

FIG. 11 is a diagram illustrating a hardware configuration example of the information processing device 30 according to the embodiment.

The information processing device 30 according to the embodiment includes a control device such as a CPU 201, a storage device such as a read only memory (ROM) 202 and a RAM 203, a communication I/F 204 that is connected to a network and performs communication, and a bus 211 that connects the units.

A computer program executed by the information processing device 30 according to the embodiment is provided by being incorporated in the ROM 202 or the like in advance.

The program executed by the information processing device 30 according to the embodiment may be configured to be recorded as a file in an installable format or an executable format on a computer-readable recording medium such as a compact disk read only memory (CD-ROM), a flexible disk (FD), or a compact disk recordable (CD-R), a digital versatile disk (DVD) or the like and provided as a computer program product.

Such a program executed by the information processing device 30 includes, for example, a processing module including an input module, a candidate information generation module, an estimation module, a recommendation module, an evaluation value acquisition module, an addition module, a repetition control module, and an output module.

This program is developed and executed on the RAM 203 by the CPU 201 (processor), thereby causing the information processing device 30 to function as the processing unit 50 including the input unit 52, the candidate information generation unit 54, the estimation unit 56, the recommendation unit 58, the evaluation value acquisition unit 60, the addition unit 62, the repetition control unit 64, and the output unit 66. Note that part or all the processing unit 50 may be configured as a hardware circuit. In addition, the RAM 203 functions as the storage unit 40.

The program executed by a computer is provided by being recorded as a file in a format that can be installed or executed in the computer in a computer-readable recording medium such as a CD-ROM, a flexible disk, a CD-R, or a digital versatile disk (DVD). Such a recording medium may be provided as a computer program product.

In addition, the program may be configured to be stored on a computer connected to a network such as the Internet and provided by being downloaded via the network. In addition, the program may be configured to be provided or distributed via a network such as the Internet. In addition, the program may be configured to be provided by being incorporated in the ROM 202 or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### SUPPLEMENTARY NOTES

The above embodiment can be summarized in the following technical schemes.

### (Technical Scheme 1)

An information processing device calculating a Pareto solution of a multi-objective optimization problem that optimizes objective functions by using evaluation devices corresponding to the objective functions, each of the objective functions including decision variables, each of the evaluation devices outputting an evaluation value for evaluating an objective function value being obtained by substituting setting values into the decision variables included in a corresponding objective function among the objective functions, the information processing device comprising
a hardware processor connected to a memory and configured to:
   generate pieces of candidate information based on data set information including one or more setting value sets, each of the pieces of candidate information including a candidate setting value set being the same as one of the one or more setting value sets;
   select recommendation candidate information from one of the pieces of candidate information;
   generate a recommendation setting value set based on the candidate setting value set included in the recommendation candidate information; and
   supply the recommendation setting value set to an evaluation device out of the evaluation devices and cause the evaluation device to generate the evaluation value.

### (Technical Scheme 2)

The information processing device according to the technical scheme 1, wherein
each of the one or more setting value sets represents the setting values,
the data set information is registered to correlate with each of the one or more setting value sets by a registered evaluation device, the registered evaluation device being an evaluation device out of the evaluation devices that has acquired the evaluation value,
each of the pieces of candidate information includes the candidate setting value set and unregistered device information indicating an unregistered evaluation device, the unregistered evaluation device being an evaluation device out of the evaluation devices that is not registered in the data set information as the registered evaluation device corresponding to the candidate setting value set, and
the hardware processor is configured to
   supply the recommendation setting value set to the unregistered evaluation device indicated by the unregistered device information included in the recommendation candidate information, and
   cause the unregistered evaluation device to generate the evaluation value.

### (Technical Scheme 3)

The information processing device according to the technical scheme 2, wherein the hardware processor is configured to
generate, for each of the pieces of candidate information, an acquisition function representing a quality of the evaluation value obtained by supplying the candidate setting value set to the unregistered evaluation device,
calculate, for each of the pieces of candidate information, an acquisition function value by giving the unregistered evaluation device and the candidate setting value set to the generated acquisition function, and
select the recommendation candidate information from among the pieces of candidate information based on the acquisition function value of each of the pieces of candidate information.

### (Technical Scheme 4)

The information processing device according to the technical scheme 3, wherein
the data set information is allowed to register the evaluation value acquired from each of the evaluation devices to correlate with each of the one or more setting value sets, and
the hardware processor is configured to
   repeat processing including generation of the pieces of candidate information, generation of the acquisition function, selection of the recommendation candidate information, and supply of the recommendation setting value set,
   acquire the evaluation value from the unregistered evaluation device every time the recommendation setting value set is supplied, and
   register, in the data set information, the unregistered evaluation device as the registered evaluation device to correlate with the supplied recommendation setting value set out of the one or more setting value sets, and register the acquired evaluation value in the data set information.

### (Technical Scheme 5)

The information processing device according to the technical scheme 4, wherein the hardware processor is configured to, in a case where a predetermined end condition is reached,
selects, from the data set information, one or more setting value sets that are non-dominated solutions with respect to the objective functions, and
output the selected one or more setting value sets as the Pareto solution.

### (Technical Scheme 6)

The information processing device according to the technical scheme 5, wherein the hardware processor is configured to, prior to the repetition of the processing, incorporate an initial setting value set representing the setting values into the data set information.

### (Technical Scheme 7)

The information processing device according to any one of the technical schemes 3 to 6, wherein
each of the evaluation devices receives at least one input value,
each of the at least one input value is one of the setting values or the evaluation value output from one of the evaluation devices, and
the hardware processor is configured to
   acquire evaluation device information including, for each of the evaluation devices, information for identifying the at least one input value and information for identifying one of the objective functions for which an evaluation value is to be output, and
   supply, to the unregistered evaluation device, the candidate setting value set included in the recommendation candidate information and the recommendation setting value set including the at least one input value, which is represented for the unregistered evaluation device in the evaluation device information, among the evaluation values registered to correlate with the candidate setting value set in the data set information.

### (Technical Scheme 8)

The information processing device according to the technical scheme 7, wherein the hardware processor is configured to generate the pieces of candidate information so as not to generate candidate information including unregistered device information indicating, as the unregistered evaluation device, an inexecutable device out of the evaluation devices, and
the inexecutable device is an evaluation device receiving, as the at least one input value, the evaluation value output from the unregistered evaluation device.

### (Technical Scheme 9)

The information processing device according to any one of the technical schemes 3 to 8, wherein the hardware processor is configured to
generate a new setting value set representing the setting values at every predetermined timing, and
add the new setting value set to the one or more setting value sets included in the data set information.

### (Technical Scheme 10)

The information processing device according to the technical scheme 9, wherein the hardware processor is configured to
generate estimation functions for estimating the objective functions, based on the data set information, and
generate the new setting value set based on the estimation functions.

### (Technical Scheme 11)

The information processing device according to the technical scheme 10, wherein the hardware processor is configured to
generate, by a genetic algorithm, a non-dominated solution of a problem that optimizes the estimation functions, and
generate the new setting value set based on the non-dominated solution.

### (Technical Scheme 12)

The information processing device according to any one of the technical schemes 3 to 11, wherein the hardware processor is configured to, for each of the pieces of candidate information,
calculate a function representing an estimated value with respect to an evaluation value obtained by supplying the candidate setting value set to the unregistered evaluation device,
calculate a function representing uncertainty of the estimated value, and
calculate the acquisition function based on the function representing the estimated value and the function representing the uncertainty of the estimated value.

### (Technical Scheme 13)

The information processing device according to the technical scheme 12, wherein the hardware processor is configured to, for each of the pieces of candidate information,
calculate a confidence region of a target objective function out of the objective functions based on the function representing the estimated value and the function representing the uncertainty of the estimated value with respect to the evaluation value obtained by supplying the candidate setting value set to the unregistered evaluation device,
calculate a confidence region of a Pareto front of the target objective function with respect to the evaluation value based on the confidence region of the target objective function, and
calculate, as the acquisition function, a function representing an amount of decrease in the confidence region of the Pareto front in a case where the function representing the uncertainty of the estimated value with respect to the estimated value is 0.

### (Technical Scheme 14)

The information processing device according to the technical scheme 12, wherein the hardware processor is configured to
calculate a first hypervolume based on a setting value set, in which the evaluation values for all the evaluation devices are registered, among the one or more setting value sets included in the data set information,
calculate, for each of the pieces of candidate information, a second hypervolume obtained by supplying the candidate setting value set to the unregistered evaluation device, based on the function representing the estimated value and the function representing the uncertainty of the estimated value with respect to each of the evaluation values obtained by supplying the candidate setting value set to the unregistered evaluation device, and
calculate, as the acquisition function, a function representing a difference between the first hypervolume and the second hypervolume for each of the pieces of candidate information.

### (Technical Scheme 15)

The information processing device according to any one of the technical schemes 1 to 14, further comprising the evaluation devices.

### (Technical Scheme 16)

An information processing method implemented by an information processing device calculating a Pareto solution of a multi-objective optimization problem that optimizes objective functions by using evaluation devices corresponding to the objective functions, each of the objective functions including decision variables, each of the evaluation devices outputting an evaluation value for evaluating an objective function value being obtained by substituting setting values into the decision variables included in a corresponding objective function among the objective functions, the method comprising:
generating pieces of candidate information based on data set information including one or more setting value sets, each of the pieces of candidate information including a candidate setting value set being the same as one of the one or more setting value sets;
selecting recommendation candidate information from one of the pieces of candidate information;
generating a recommendation setting value set based on the candidate setting value set included in the recommendation candidate information; and
supplying the recommendation setting value set to an evaluation device out of the evaluation devices and causing the evaluation device to generate the evaluation value.

### (Technical Scheme 17)

A computer program product comprising a non-transitory computer readable recording medium on which a computer program executable by a computer as an information processing device is recorded, the information processing device calculating a Pareto solution of a multi-objective optimization problem that optimizes objective functions by using evaluation devices corresponding to the objective functions, each of the objective functions including decision variables, each of the evaluation devices outputting an evaluation value for evaluating an objective function value being obtained by substituting setting values into the decision variables included in a corresponding objective function among the objective functions, the computer program instructing the computer to perform processing, the processing including:
generating pieces of candidate information based on data set information including one or more setting value sets, each of the pieces of candidate information including a candidate setting value set being the same as one of the one or more setting value sets;
selecting recommendation candidate information from one of the pieces of candidate information;
generating a recommendation setting value set based on the candidate setting value set included in the recommendation candidate information; and
supplying the recommendation setting value set to an evaluation device out of the evaluation devices and causing the evaluation device to generate the evaluation value.

What is claimed is:

1. An information processing device calculating a Pareto solution of a multi-objective optimization problem that optimizes objective functions by using evaluation devices corresponding to the objective functions, each of the objective functions including decision variables, each of the evaluation devices outputting an evaluation value for evaluating an objective function value being obtained by substituting setting values into the decision variables included in a corresponding objective function among the objective functions, the information processing device comprising
a hardware processor connected to a memory and configured to:
generate pieces of candidate information based on data set information including one or more setting value sets, each of the pieces of candidate information including a candidate setting value set being the same as one of the one or more setting value sets;
select recommendation candidate information from one of the pieces of candidate information;
generate a recommendation setting value set based on the candidate setting value set included in the recommendation candidate information; and
supply the recommendation setting value set to an evaluation device out of the evaluation devices and cause the evaluation device to generate the evaluation value.

2. The information processing device according to claim 1, wherein
each of the one or more setting value sets represents the setting values,
the data set information is registered to correlate with each of the one or more setting value sets by a registered evaluation device, the registered evaluation device being an evaluation device out of the evaluation devices that has acquired the evaluation value,
each of the pieces of candidate information includes the candidate setting value set and unregistered device information indicating an unregistered evaluation device, the unregistered evaluation device being an evaluation device out of the evaluation devices that is not registered in the data set information as the registered evaluation device corresponding to the candidate setting value set, and
the hardware processor is configured to
supply the recommendation setting value set to the unregistered evaluation device indicated by the unregistered device information included in the recommendation candidate information, and
cause the unregistered evaluation device to generate the evaluation value.

3. The information processing device according to claim 2, wherein the hardware processor is configured to
generate, for each of the pieces of candidate information, an acquisition function representing a quality of the evaluation value obtained by supplying the candidate setting value set to the unregistered evaluation device,
calculate, for each of the pieces of candidate information, an acquisition function value by giving the unregistered evaluation device and the candidate setting value set to the generated acquisition function, and
select the recommendation candidate information from among the pieces of candidate information based on the acquisition function value of each of the pieces of candidate information.

4. The information processing device according to claim 3, wherein
the data set information is allowed to register the evaluation value acquired from each of the evaluation devices to correlate with each of the one or more setting value sets, and
the hardware processor is configured to
repeat processing including generation of the pieces of candidate information, generation of the acquisition function, selection of the recommendation candidate information, and supply of the recommendation setting value set,
acquire the evaluation value from the unregistered evaluation device every time the recommendation setting value set is supplied, and
register, in the data set information, the unregistered evaluation device as the registered evaluation device to correlate with the supplied recommendation setting value set out of the one or more setting value sets, and register the acquired evaluation value in the data set information.

5. The information processing device according to claim 4, wherein the hardware processor is configured to, in a case where a predetermined end condition is reached,
selects, from the data set information, one or more setting value sets that are non-dominated solutions with respect to the objective functions, and
output the selected one or more setting value sets as the Pareto solution.

6. The information processing device according to claim 5, wherein the hardware processor is configured to, prior to the repetition of the processing, incorporate an initial setting value set representing the setting values into the data set information.

7. The information processing device according to claim 3, wherein
each of the evaluation devices receives at least one input value,
each of the at least one input value is one of the setting values or the evaluation value output from one of the evaluation devices, and
the hardware processor is configured to
acquire evaluation device information including, for each of the evaluation devices, information for identifying the at least one input value and information for identifying one of the objective functions for which an evaluation value is to be output, and
supply, to the unregistered evaluation device, the candidate setting value set included in the recommendation candidate information and the recommendation setting value set including the at least one input value, which is represented for the unregistered evaluation device in the evaluation device information, among the evaluation values registered to correlate with the candidate setting value set in the data set information.

8. The information processing device according to claim 7, wherein the hardware processor is configured to generate the pieces of candidate information so as not to generate candidate information including unregistered device information indicating, as the unregistered evaluation device, an inexecutable device out of the evaluation devices, and
the inexecutable device is an evaluation device receiving, as the at least one input value, the evaluation value output from the unregistered evaluation device.

9. The information processing device according to claim 3, wherein the hardware processor is configured to
generate a new setting value set representing the setting values at every predetermined timing, and
add the new setting value set to the one or more setting value sets included in the data set information.

10. The information processing device according to claim 9, wherein the hardware processor is configured to
generate estimation functions for estimating the objective functions, based on the data set information, and
generate the new setting value set based on the estimation functions.

11. The information processing device according to claim 10, wherein the hardware processor is configured to
generate, by a genetic algorithm, a non-dominated solution of a problem that optimizes the estimation functions, and
generate the new setting value set based on the non-dominated solution.

12. The information processing device according to claim 3, wherein the hardware processor is configured to, for each of the pieces of candidate information,
calculate a function representing an estimated value with respect to an evaluation value obtained by supplying the candidate setting value set to the unregistered evaluation device,
calculate a function representing uncertainty of the estimated value, and
calculate the acquisition function based on the function representing the estimated value and the function representing the uncertainty of the estimated value.

13. The information processing device according to claim 12, wherein the hardware processor is configured to, for each of the pieces of candidate information,
calculate a confidence region of a target objective function out of the objective functions based on the function representing the estimated value and the function representing the uncertainty of the estimated value with respect to the evaluation value obtained by supplying the candidate setting value set to the unregistered evaluation device,
calculate a confidence region of a Pareto front of the target objective function with respect to the evaluation value based on the confidence region of the target objective function, and
calculate, as the acquisition function, a function representing an amount of decrease in the confidence region of the Pareto front in a case where the function representing the uncertainty of the estimated value with respect to the estimated value is 0.

14. The information processing device according to claim 12, wherein the hardware processor is configured to
calculate a first hypervolume based on a setting value set, in which the evaluation values for all the evaluation devices are registered, among the one or more setting value sets included in the data set information,
calculate, for each of the pieces of candidate information, a second hypervolume obtained by supplying the candidate setting value set to the unregistered evaluation device, based on the function representing the estimated value and the function representing the uncertainty of the estimated value with respect to each of the evaluation values obtained by supplying the candidate setting value set to the unregistered evaluation device, and
calculate, as the acquisition function, a function representing a difference between the first hypervolume and the second hypervolume for each of the pieces of candidate information.

15. The information processing device according to claim 1, further comprising the evaluation devices.

16. An information processing method implemented by an information processing device calculating a Pareto solution of a multi-objective optimization problem that optimizes objective functions by using evaluation devices corresponding to the objective functions, each of the objective functions including decision variables, each of the evaluation devices outputting an evaluation value for evaluating an objective function value being obtained by substituting setting values into the decision variables included in a corresponding objective function among the objective functions, the method comprising:
generating pieces of candidate information based on data set information including one or more setting value sets, each of the pieces of candidate information including a candidate setting value set being the same as one of the one or more setting value sets;
selecting recommendation candidate information from one of the pieces of candidate information;
generating a recommendation setting value set based on the candidate setting value set included in the recommendation candidate information; and
supplying the recommendation setting value set to an evaluation device out of the evaluation devices and causing the evaluation device to generate the evaluation value.

17. A computer program product comprising a non-transitory computer readable recording medium on which a computer program executable by a computer as an information processing device is recorded, the information processing device calculating a Pareto solution of a multi-objective optimization problem that optimizes objective functions by using evaluation devices corresponding to the objective functions, each of the objective functions including decision variables, each of the evaluation devices outputting an evaluation value for evaluating an objective function value being obtained by substituting setting values into the decision variables included in a corresponding objective function among the objective functions, the computer program instructing the computer to perform processing, the processing including:
generating pieces of candidate information based on data set information including one or more setting value sets, each of the pieces of candidate information including a candidate setting value set being the same as one of the one or more setting value sets;
selecting recommendation candidate information from one of the pieces of candidate information;
generating a recommendation setting value set based on the candidate setting value set included in the recommendation candidate information; and
supplying the recommendation setting value set to an evaluation device out of the evaluation devices and causing the evaluation device to generate the evaluation value.
